(19) United States
(12) Patent Application Publication
(10) Pub. No.: US 2008/0077332 A1
(43) Pub. Date: Mar. 27, 2008

(54) Fatigue measurement method for coiled tubing & wireline

(76) Inventor: Kenneth Ray Newman, Willis, TX (US)

Correspondence Address: Guy McClung, #114, 5315-B F.M. 1960 Rd. West, Houston, TX, 77069-4410, US

(21) Appl. No.: 11/526,842

(22) Filed: Sep. 25, 2006

(51) Int. Cl. G06F 19/00

(52) U.S. Cl. 702/34; 702/1; 702/127; 702/33; 702/113

(57) ABSTRACT

A method for determining fatigue life reduction in a string; the method, in at least certain aspects, including providing at least one sample from a string that has been subjected to corrosion, fatigue testing the at least one sample to determine a measured remaining fatigue life, calculating an expected remaining bending fatigue life for the at least one sample, and comparing the measured remaining fatigue life to the expected remaining bending fatigue life to determine the extent of reduction in fatigue life of the string.

### BACKGROUND OF THE INVENTION

1. Field of the Invention

The present invention is directed to fatigue measurement of pipe, wire, and wireline.

2. Description of Related Art

Coiled tubing (“CT”) is pipe which can be run in and out of a pipeline, tubular string, borehole, or wellbore. CT is typically made of steel alloys including carbon steel and stainless steel. The CT is stored on and spooled from a reel. In winding onto the reel, the CT is bent. Typically the CT is fed or spooled from the reel over a gooseneck or guide arch or an injector for directing the CT into a bore or well. When run into and out of a well, the CT is straightened as it comes off of the reel, bent as it goes around the guide arch, and straightened as it goes through the injector and into the well. When being pulled out of a well, the CT is bent around the guide arch, straightened as it goes towards the reel, then bent onto the reel. Thus in one trip in and out of a well, a given section of the CT is subjected to multiple (in this case six) bending and straightening events.

Axial loads are applied to the CT both while it is being bent and straightened and while it is straight between the reel and guide arch (reel back tension) and while it is straight in a well. Internal pressure is usually applied when fluids are pumped through the CT. Repeated bending cycles can damage coiled tubing. The effects of this damage, known as fatigue damage, accumulate until the CT eventually fails. Failure is defined as the point at which the coiled tubing can no longer hold internal pressure, or, in extreme situations, the point at which the coiled tubing breaks. The fatigue life is the useful life of the CT before it fails due to accumulated fatigue damage.

Wireline (“WL”) is a generic term for cable that is run in and out of wells. WL may be a single strand of steel or stainless steel wire, also known as “Slickline”. WL may also be braided steel or stainless steel cable. WL may also be an electric cable with electric conductors surrounded by armor wires or located inside a small diameter steel tube.

WL is stored on a storage reel. When being run in and out of a well the WL passes from the storage reel around multiple pulleys or sheaves, and into the well. The WL has an axial load when it is bent on and off the reel and around the sheaves. This bending can cause fatigue damage, which can accumulate until the WL fails. Failure is defined as breaking of the entire WL or one of the components (electrical conductors, armor wires, etc.) which make up the WL.

Computer fatigue models and databases (such as the commercially-available CTES Cerberus ((trademark)) software co-owned with the present invention) may be used to track the fatigue life of CT and WL. The CT or WL is divided into sections (for example, 10 ft lengths) for tracking purposes. Data from the usage of the CT or WL such as bending events, axial force, rotational orientation and internal pressure can be gathered for each section. This data is then used to calculate the fatigue damage to the CT or WL. The sum of the fatigue damage is used to calculate the fatigue life of the CT or WL. Typically this fatigue life is discussed in terms of the “1% Life Used”. A graph may be generated showing the % Life Used along the length of the CT or WL. Once the % Life Used reaches some limit, typically 80%, the CT or WL may be taken out of service, or some change is made so that that section of the CT or WL is no longer used.

FIG. 1 shows a prior art WL fatigue tracking system. A data acquisition system 102 senses parameters from sensors 101 on a WL unit while the WL is being run in and out of wells. These parameters include the depth and axial force on the WL. These parameters are passed to a Fatigue Damage Model 103 which uses them to calculate the fatigue damage for each section of the WL. The output of the fatigue damage model is a plot 104 showing the % Fatigue Life Used (vertical axis) along the length (horizontal axis) of the WL 105. This plot 104 also shows a safe working limit 106 after which the WL or part of the WL can no longer safely be used.

Fatigue testing, typically of new CT or WL, is used to develop computer fatigue models. Fatigue test machines (“FTM”) bend and straighten the CT or WL repeatedly, counting the number of “cycles” (typically a bend and straighten is defined as one cycle) until failure. A CT FTM applies internal pressure to the sample of CT, and failure is determined when a leak occurs. FTMs may apply an axial load to the CT or WL. They may also rotate the CT or WL between or during cycles. In some cases the sample is rotated while curved which is equivalent to a bending cycle for each revolution. Test results from these FTMs are used to develop the fatigue damage properties and algorithms used by the computer fatigue damage models which track the fatigue life for the CT or WL.

FIG. 2 shows a schematic of a prior art CT FTM known as the “beer pump”. A straight sample of CT 201 is inserted into the machine next to a straight form 205. An hydraulic piston 204 pulls the CT sample around a curved form 206 to a bent position 202 using rollers 203 to ensure no axial load is applied. The piston 204 then pushes the CT sample back to a straight position against the straight form 205. Internal pressure (not shown) is maintained in the CT sample until the pressure leaks through a fatigue crack in the CT. The bending cycles are counted by a data acquisition system (not shown). The total number of bending cycles to failure of the sample is an indication of its fatigue life.

FIG. 3 shows a schematic of a prior art WL (in this case Slickline) FTM. A sample of slickline 301 is held in a circular arc between rotating chucks 303 and 304. Chuck 303 is driven by an electric motor 302. Chuck 304 is held by a bearing support and is free to rotate. The electric motor 302 rotates the line 301. Each rotation is equivalent to one bending cycle. The number of rotations is counted by a data acquisition device (not shown) and displayed by an electronic display 305.

Both CT and WL experience significant corrosion due to exposure to the atmosphere and various wellbore fluids, e.g., but not limited to, water and oxygen (causing rust), acid, carbon dioxide, and hydrogen sulfide. Usually this corrosion is most severe for the downhole end of the CT or WL, because this end sees the highest temperatures and pressures. This corrosion reduces the fatigue life of the CT or WL. Though much research has been done regarding the corrosion mechanisms, the present inventor is unaware of any method available today to quantify the reduction in fatigue life due to corrosion.

There is a need, recognized by the present inventor, for a method of determining the amount of CT or WL fatigue life reduction due to corrosion.

### BRIEF SUMMARY OF THE PRESENT INVENTION

The present invention teaches methods of determining the CT or WL fatigue life reduction due to corrosion, bending, etc.

The present invention, in at least certain aspects, discloses method for determining fatigue life reduction of a string (coiled tubing or wireline), the methods including: providing at least one sample (or multiple samples) from a string, the string and the at least one sample or samples having been subjected to corrosion; fatigue testing the at least one sample (or samples) providing an actual fatigue test result; calculating an expected fatigue result for the at least one sample (or an average for the samples), the calculating not taking the corrosion into account; and comparing the actual fatigue test result to the expected fatigue result to determine how much the corrosion has reduced the fatigue life of the string.

The present invention teaches, in at least certain aspects, computer readable media containing instructions that when executed by a computer implement implementable steps of methods according to the present invention; and, in certain aspects, computer readable media containing instructions that when executed by a computer, implement methods for determining fatigue life reduction in a string due to corrosion, a measured value for a remaining fatigue life of at least one sample from the string input into the computer, said measured value determined by fatigue testing the at least one sample, the methods including calculating an expected remaining bending fatigue life for the at least one sample, and comparing the measured value for the remaining fatigue life to the expected remaining bending fatigue life to determine the extent of reduction in fatigue life.

In certain aspects, methods according to the present invention assume that the downhole end of the CT or WL is as corroded as any other portion of the CT or WL and a sample or samples are taken from the downhole end. In other aspects, corrosion or breaking of a specific section of the CT or WL is considered and a sample or samples are taken from the specific area. In any method according to the present invention, the results of any and all steps may be displayed, e.g., but not limited to, on a screen or screens and/or on a chart or strip chart.

In certain embodiments, the following steps are used to determine the effect of this corrosion on fatigue. In a first step a sample or multiple samples are cut from the CT or WL (from the downhole end or from an area for which corrosion is a concern).

In a second step this sample or these samples are tested using a FTM, providing the number of cycles to failure (“FTMcyc”) for a specific configuration of the FTM test; if multiple samples are tested, FTMcyc is the average of the number of cycles to failure. Alternatively, a minimum number of cycles to failure (worst case) may be used as FTMcyc.

In a third step a computer fatigue model is used to calculate the expected remaining bending fatigue life for CT or WL samples. The computer model calculates the expected number of cycles to failure due to bending, (designated as “MDLcyc” for reference purposes). MDLcyc is the expected bending fatigue life with no corrosion.

In a fourth step the fatigue test results from the samples are compared to the expected results from the computer model to determine if there is any significant reduction in the fatigue.

If there is a reduction in fatigue life indicated, in a fifth step the percentage of the expired fatigue life due to corrosion is calculated.

In a sixth step this additional expired fatigue life due to corrosion is taken into consideration.

In certain aspects, the present invention discloses, methods for determining fatigue life reduction of a string, the methods including: providing at least one sample from a string (coiled tubing or wireline), the string and the at least one sample having been subjected to corrosion; fatigue testing the at least one sample providing an actual fatigue test result; calculating an expected bending fatigue result for the at least one sample; and comparing the actual fatigue test result to the expected bending fatigue result to determine how much the corrosion has reduced the fatigue life of the string.

In certain aspects, the present invention discloses methods for determining reduction in fatigue life of a string (coiled tubing or wireline), the methods including: providing at least one sample from a string, the string and the at least one sample having been subjected to corrosion; fatigue testing the at least one sample to determine a measured remaining fatigue life for the at least one sample; calculating an expected remaining bending fatigue life for the at least one sample; comparing the measured remaining fatigue life to the expected remaining bending fatigue life to determine an extent of reduction in fatigue life of the string.

In certain aspects, the present invention provides appropriately programmed computer(s) to carry out steps of methods according to the present invention. In certain aspects, the present invention discloses a computer readable medium containing instructions that when executed by a computer implement a method for determining fatigue life reduction in a string (coiled tubing or wireline) due to corrosion, a measured value for a remaining fatigue life of at least one sample from the string input into a computer with the computer readable medium, the measured value determined by fatigue testing the at least one sample, the method including: calculating an expected remaining bending fatigue life for the at least one sample; and comparing the measured value for the remaining fatigue life to the expected remaining bending fatigue life to determine how much reduction in fatigue life has occurred due to the corrosion.

In certain aspects, the present invention discloses methods for determining fatigue life reduction in a string (coiled tubing or wireline), the methods including: providing at least one sample from a string (from a downhole end thereof or from a specific area impacted by the corrosion), the string and the at least one sample thereof having been subjected to corrosion; fatigue testing the at least one sample to determine a remaining fatigue life for the at least one sample; calculating an expected remaining bending fatigue life for the at least one sample; comparing the remaining fatigue life to the expected remaining bending fatigue life to determine how much the fatigue life of the string has been reduced due to corrosion. In certain aspects, life reduction due to corrosion is assumed to be the same for the entire string. Bending fatigue is not necessarily the same for the entire string and can vary depending on how the string has been used, but the computer models calculate effects of bending fatigue based on input about the usage of the string. Calculations of remaining bending fatigue life for a sample are done for the configuration of the FTM; i.e. the FTM has a certain bending radius of curvature, and for the case of CT, a certain internal pressure. The model calculation is done for this specific configuration. The computer model simulates the bending of an FTM for the current point in the life of the string where the sample was removed.

Accordingly, the present invention includes features and advantages which are believed to enable it to advance fatigue testing technology. Characteristics and advantages of the present invention described above and additional features and benefits will be readily apparent to those skilled in the art upon consideration of the following detailed description of preferred embodiments and referring to the accompanying drawings.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide:

New, useful, unique, efficient, non-obvious corrosion and bending fatigue life testing methods for coiled tubing and wireline.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention or of the claims in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1 is a schematic view of a prior art system.

FIG. 2 is a schematic view of a prior art system.

FIG. 3 is a schematic view of a prior art system.

FIG. 4 is a schematic view of a method according to the present invention.

FIG. 5 is a schematic view of results of a method according to the present invention.

Presently preferred embodiments of the invention are shown in the above-identified figures and described in detail below. It should be understood that the appended drawings and description herein are of preferred embodiments and are not intended to limit the invention or the appended claims. On the contrary, the intention is to cover all modifications, equivalents and alternatives falling within the spirit and scope of the invention as defined by the appended claims. In showing and describing the preferred embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiment, and are not intended to mean the claimed invention of any particular appended claim(s) or all of the appended claims. Accordingly, the subject or topic of each such reference is not automatically or necessarily part of, or required by, any particular claim(s) merely because of such reference.

### DETAILED DESCRIPTION OF THE INVENTION

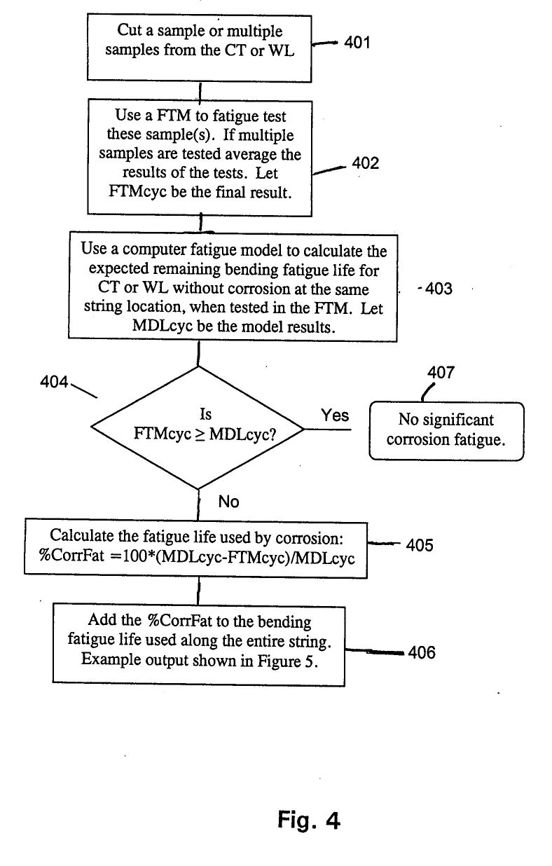

As illustrated schematically in FIG. 4, in certain embodiments the present invention teaches methods of determining the CT or WL fatigue life reduction due to adverse events, e.g. bending, corrosion, etc. In certain aspects, these methods assume that a downhole end of the CT or WL is as corroded as any other portion of the CT or WL. In other aspects, methods according to the present invention focus on a portion or portions of CT or WL which is broken or in which significant corrosion is suspected.

When the CT or WL has been used and has suffered due to adverse events, a sample or multiple samples are taken (e.g. cut) from the CT or WL (step 401). The length of these samples is defined by the FTM which will be used in a testing step. In certain aspects, typical samples range between one foot and nine feet in length.

The sample or samples are tested using a FTM (step 402), producing a measured number of cycles to failure for the specific configuration of the FTM test (radius of curvature, internal pressure, etc.) (designated as “FTMcyc” for reference purposes). Optionally, multiple samples are tested and the average of the number of cycles to failure of the samples is used. Alternatively the minimum number of cycles to failure (worst case) may be used as FTMcyc.

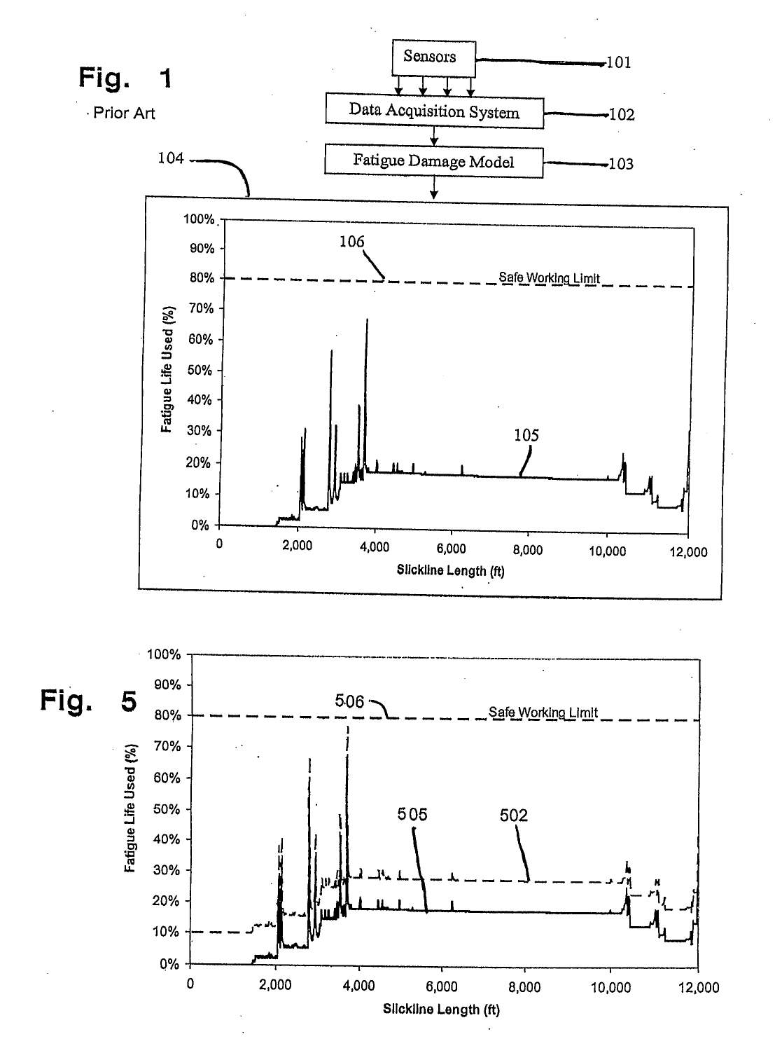

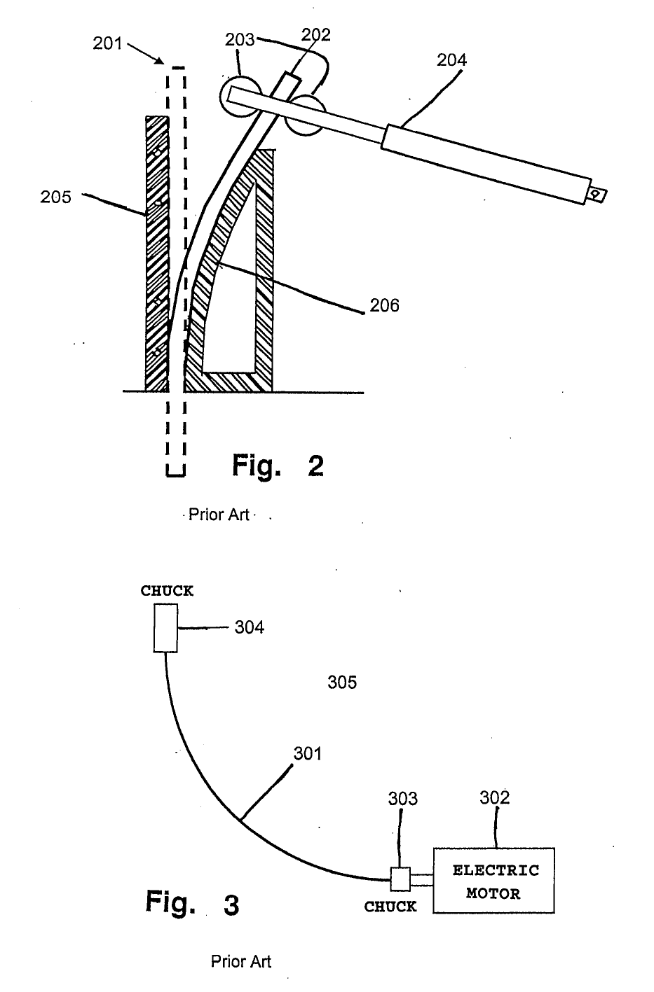

Then a computer fatigue model is used for the particular CT or WL, to calculate an expected remaining bending fatigue life for the sample(s) for the FTM test with the same specific configuration (radius of curvature, internal pressure, etc.) used in testing the sample(s) (step 404). This assumes that the computer model has been used as described in FIG. 1 to calculate the fatigue life, 105, of the string up to the time the sample(s) were taken from the string. This model is then used for the section of CT or WL from which the sample(s) originated, to calculate how much bending fatigue life this section should have (assuming no adverse corrosion) when tested in the FTM. Thus the computer takes into account the calculated fatigue state that the string already had before the sample was removed from the string and calculates how much life (how many cycles) should result when the sample is tested on the FTM. The computer model calculates the expected number of cycles to failure, “MDLcyc,” the sample(s) should endure (with no corrosion) when tested in the FTM.

The fatigue test result, FTMcyc, is compared (step 404) to the expected results from the computer model, MDLcyc. If the fatigue test result, FTMcyc, is greater than or equal to the computer model result, MDLcyc, this indicates no significant reduction in the fatigue life due to corrosion, and this process is finished, (step 407). However, if the fatigue test result, FTMcyc, is less than the computer model result, MDLcyc, there is a reduction in the fatigue life due to corrosion and the process continues. In a next step 405, the percentage of the fatigue life lost to corrosion, % CorrFat, is calculated. This may be done using the following formula:

$$\% CorrFat = 100 [ \frac{MDLcyc - FTMcyc}{MDLcyc} ]$$

In a final step 406, this additional fatigue is taken into consideration. This can be done in several different ways. In the step 406 (and as shown by line 502, FIG. 5) this is done by simply adding the % CorrFat to the % Life Used along the entire length of the CT or WL. Alternatively, for coiled tubing the % CorrFat can be reduced for sections of the CT string that have a thicker wall than the section which was tested and increased for sections of the CT string that have a thinner wall than the section which was tested. This adjusted % CorrFat is then added to the % Life Used along the entire length of the CT. Alternatively this % CorrFat is used to reduce the Safe Working Limit 506 (see FIG. 5). Thus, according to the present invention, there are three different ways of dealing with the % CorrFat. In the first one, the % Life Used is increased by the % CorrFat (e.g. as in FIGS. 4, 5). In the second, the % CorrFat is ratioed by the CT wall thickness and added to the % Life Used. In the third, the % CorrFat is subtracted from the safe working limit.

FIG. 5 illustrates graphically the results from a method according to the present invention. Line 505 is like the line 105, FIG. 1. Line 502 indicates the summation of the % CorrFat and the % Life Used.

The present invention, therefore, in at least certain aspects, provides a method for determining fatigue life reduction of a string, the method including: providing at least one sample from a string, the string and the at least one sample having been subjected to corrosion; fatigue testing the at least one sample providing an actual fatigue test result; calculating an expected fatigue result for the at least one sample, said calculating not taking the corrosion into account; and comparing the actual fatigue test result to the expected fatigue result to determine how much the corrosion has reduced the fatigue life of the string.

The present invention, therefore, in at least certain aspects, provides a method for determining reduction in fatigue life of a string, the method including: providing at least one sample from a string, the string and the at least one sample having been subjected to corrosion; fatigue testing the at least one sample to determine a measured remaining fatigue life for the at least one sample; calculating an expected remaining bending fatigue life for the at least one sample; and comparing the measured remaining fatigue life to the expected remaining bending fatigue life to determine an extent of reduction in fatigue life of the string.

The present invention, therefore, in at least certain aspects, provides a computer readable medium containing instructions that when executed by a computer implement a method for determining fatigue life reduction in a string due to corrosion, a measured value for a remaining fatigue life of at least one sample from the string input into the computer, said measured value determined by fatigue testing the at least one sample, the method including: calculating an expected remaining bending fatigue life for the at least one sample; and comparing the measured value for the remaining fatigue life to the expected remaining bending fatigue life to determine how much reduction in fatigue life has occurred.

The present invention, therefore, in at least certain aspects, provides a method for determining fatigue life reduction in a string (wireline or coiled tubing), the method including: providing at least one sample from a string, the string and the at least one sample thereof having been subjected to corrosion; fatigue testing the at least one sample to determine a remaining fatigue life for the at least one sample; calculating an expected remaining bending fatigue life for the at least one sample; and comparing the remaining fatigue life to the expected remaining bending fatigue life to determine how much the fatigue life of the string has been reduced due to corrosion. Such a method may include one or some (in any possible combination) of the following: determining the remaining fatigue life due to corrosion in measured number of cycles to failure for the at least one sample and calculating the expected remaining bending fatigue life in expected number of cycles to failure, and comparing the expected number of cycles to failure to the measured number of cycles to failure to determine reduction in fatigue life of the string; in calculating the expected remaining bending fatigue life, taking into account bending of the at least one sample that has occurred; the at least one sample is a plurality of samples, subjecting each sample of the plurality of samples is subject to a fatigue test, each of said tests yielding a measured number of cycles to failure for a corresponding sample, and to determine an average tested number of cycles to failure to be used to compare to a calculated expected number of cycles to failure, taking an average of the measured numbers of cycles to failure for all the samples, producing an average tested number of cycles to failure; calculating an expected remaining bending fatigue life for each sample of the plurality of samples and taking an average to determine an average expected number of cycles to failure, and in the comparing step, comparing the average expected number of cycles to failure to the average tested number of cycles to failure; displaying results of the fatigue testing step, and/or the calculating step, and/or the comparing step; the at least one sample ranging in length between one foot and nine feet; the at least one sample is a plurality of samples, fatigue testing each sample of the plurality of samples and determining a remaining fatigue life for each sample, of all the determined remaining fatigue lifes, using the minimum remaining fatigue life in the comparing step as the remaining fatigue life; taking the at least one sample from a downhole end of the string or from a specific corroded area; calculating fatigue life lost due to corrosion for the at least one sample; calculating the fatigue life lost due to corrosion, % CorrFat, by the formula

$$\% CorrFat = 100 [ \frac{MDLcyc - FTMcyc}{MDLcyc} ]$$

; and the string is coiled tubing, the coiled tubing has a safe working limit, and using the calculated fatigue life lost due to corrosion to reduce the safe working limit; the string is coiled tubing, the coiled tubing at the time of the fatigue test has a % Life Used, and adding the calculated fatigue life lost due to corrosion to the % Life Used along an entire length of the coiled tubing; the string is coiled tubing, the coiled tubing has a length, the at least one sample has a sample thickness, the coiled tubing has a portion with a portion thickness greater than the sample thickness, the string has a % Life Used, and adjusting the fatigue life lost due to corrosion based on the portion thickness producing an adjusted fatigue life lost due to corrosion, and adding the adjusted fatigue life lost due to corrosion to the % Life Used along the length of the coiled tubing producing a summation; and/or displaying the summation.

All patents referred to herein by number are incorporated fully herein for all purposes. In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims.

1-21. (canceled)

22. A method for determining fatigue life reduction of a string due to corrosion, the method comprising
providing at least one sample from a string, the string and the at least one sample having been subjected to corrosion,
fatigue testing the at least one sample providing an actual fatigue test result,
calculating an expected fatigue result for the at least one sample, said calculating not taking the corrosion into account,
determining whether the string's fatigue life has been reduced due to corrosion by comparing the actual fatigue test result to the expected fatigue result.

23. A computer readable medium containing instructions, that when executed by a computer, implement a method for determining fatigue life reduction in a string due to corrosion, the method including
calculating an expected remaining bending fatigue life for the at least one sample, said calculating not taking the corrosion into account, and
determining whether reduction in fatigue life has occurred due to corrosion by comparing the measured value for the remaining fatigue life to the expected remaining bending fatigue life,
wherein a measured value for a remaining fatigue life of at least one sample from the string is input into the computer, and said measured value is determined by fatigue testing the at least one sample.

24. A method for determining fatigue life reduction in a string due to corrosion, the method comprising
providing at least one sample from a string, the string and the at least one sample thereof having been subjected to corrosion,
fatigue testing the at least one sample to determine a remaining fatigue life for the at least one sample,
calculating an expected remaining bending fatigue life for the at least one sample, said calculating not taking the corrosion into account, and
determining whether the fatigue life of the string has been reduced due to corrosion by comparing the remaining fatigue life to the expected remaining bending fatigue life.

25. The method of claim 24 further comprising
determining a remaining fatigue life due to corrosion in measured number of cycles to failure for the at least one sample,
calculating the expected remaining bending fatigue life in expected number of cycles to failure, and
determining reduction in fatigue life of the string due to corrosion by comparing the expected number of cycles to failure to the measured number of cycles to failure.

26. The method of claim 24 wherein in calculating the expected remaining bending fatigue life, bending of the at least one sample that has occurred is taken into account.

27. The method of claim 24 further comprising
the at least one sample is a plurality of samples,
each sample of the plurality of samples Is subjected to a fatigue test, each of said fatigue test yielding a measured number of cycles to failure for a corresponding sample, and
determining an average tested number of cycles to failure,
comparing the average number of cycles to failure to a calculated expected number of cycles to failure,
taking an average of the measured numbers of cycles to failure for all the samples, and
producing an average tested number of cycles to failure.

28. The method of claim 27 further comprising
calculating an expected remaining bending fatigue life for each sample of the plurality of samples and taking an average to determine an average expected number of cycles to failure, and
in the comparing step, comparing the average expected number of cycles to failure to the average tested number of cycles to failure.

29. The method of claim 24 further comprising
displaying results of the fatigue testing step, the calculating step, and the comparing step.

30. The method of claim 25 further comprising
displaying results of the fatigue testing step, the calculating step, and the comparing step.

31. The method of claim 24 wherein the string is wireline.

32. The method of claim 24 wherein the at least one sample ranges in length between one foot and nine feet.

33. The method of claim 24 wherein
the at least one sample is a plurality of samples,
each sample of the plurality of samples is fatigue tested and a remaining fatigue life is determined for each sample,
of all the determined remaining fatigue lives, the minimum remaining fatigue life is used in the comparing step as the remaining fatigue life.

34. The method of claim 24 wherein the at least one sample is taken from a downhole end of the string.

35. The method of claim 24 further comprising
determining that the fatigue life of the string has been reduced due to corrosion, and
calculating the percentage of fatigue life lost due to corrosion for the at least one sample.

36. The method of claim 35 wherein the fatigue life lost due to corrosion is % CorrFat and is calculated by the formula
$$\% CorrFat = 100 [ \frac{MDLcyc - FTMcyc}{MDLcyc} ]$$

37. The method of claim 24 wherein the string is coiled tubing.

38. The method of claim 35 wherein the string is coiled tubing, the coiled tubing has a safe working limit, and
the calculated fatigue life lost due to corrosion is used to reduce the safe working limit.

39. The method of claim 35 wherein the string is coiled tubing, the coiled tubing at the time of the fatigue test has a % Life Used, and
the calculated fatigue life lost due to corrosion is added to the % Life Used along an entire length of the coiled tubing.

40. The method of claim 35 wherein the string is coiled tubing, the coiled tubing has a length, the at least one sample has a sample thickness, the coiled tubing has a portion with a portion thickness greater than the sample thickness, the string has a % Life Used, and
the fatigue life lost due to corrosion is adjusted based on the portion thickness producing an adjusted fatigue life lost due to corrosion, and
the adjusted fatigue life lost due to corrosion is added to the % Life Used along the length of the coiled tubing producing a summation.

41. The method of claim 40 further comprising
displaying the summation.
